(19) United States
(12) Patent Application Publication
(10) Pub. No.: US 2006/0274283 A1
(43) Pub. Date: Dec. 7, 2006

(54) REAR PROJECTION DISPLAY

(76) Inventors: Yu-Ti Lin, Taipei City (TW); Shih-Min Wu, Yilan County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,176

(22) Filed: Jul. 26, 2005

(30) Foreign Application Priority Data
Jun. 3, 2005 (TW) 94118311

(51) Int. Cl. G03B 21/28

(52) U.S. Cl. 353/74

(57) ABSTRACT

A rear projection display, including a base, a partition, a frame, and an optical engine, is provided. The partition is disposed in the base for defining a system space and a lens adjusting space, wherein the system space and the lens adjusting space are exposed by a front opening on the base. The optical engine is disposed in the system space, and a projection lens of the optical engine protrudes into the lens adjusting space. The frame is disposed on the base for fixing a screen. The focal length can be directly adjusted through the lens adjusting space, and the projection effect can be observed simultaneously from the screen.

### CROSS-REFERENCE TO RELATED APPLICATION

This application claims the priority benefit of Taiwan application serial no. 94118311, filed on Jun. 3, 2005. All disclosure of the Taiwan application is incorporated herein by reference.

### BACKGROUND OF THE INVENTION

1. Field of the Invention

The present invention generally relates to a rear projection display. More particularly, the present invention relates to a rear projection, which provides more convenience for adjusting the focal length of a projection lens.

2. Description of Related Art

Recently, rear projection display apparatus has come to be used in the field of large scale display, such as TV or home theater. FIG. 1 schematically illustrates a conventional rear projection display, which comprises a frame 10, a screen 11, a base 12, and a back housing 14. The screen 111 is disposed in the frame 10 and above the base 12, in which electronic devices, such as an optical engine 16, a circuit board, and a power supply, are disposed. In addition, the optical engine 16 comprises a set of projection lens 17. A reflector is disposed within the back housing 14 and behind the frame 10.

According to the imaging principle of the rear projection display, a light beam 20 including image data is produced by the optical engine 16 in the base. The light beam 20 is focused by the set of projection lens 17 and transmitted to the reflector 18. Then, the reflector 18 reflected the light beam 20 to the screen 11 for displaying an image on the screen 11. Specifically, whether the image formed on the screen 11 is clear is depend on the focal length of the set of projection lens 17. Therefore, before leaving the factory, a manually adjustment to the focal length of the set projection lens 17 is performed to ensure that the light beam 20 can be precisely focused on the screen 11.

Referring to FIG. 2, which schematically illustrates a front view of the rear projection display in FIG. 1. Recently, the set of projection lens 17 are disposed between the frame 10 and the base 12, wherein the amount of the projection lenses 17 may be three according to the primary colors: red, blue, and green. However, when the image can not be precisely formed on the screen 11 and the manually adjustment is performed, the frame 10 and the screen 11 need to be disassembled, and then the focal length of the set of projection lens 17 is adjusted. After that, the frame 10 and the screen 11 are assembled for testing. However, the burdensome steps of disassembling, assembling, and testing may waste a lot of manpower, as well as the production time.

Furthermore, in another type of rear projection display, the back housing 14 has an opening, through which a worker can adjust the focal length of the set of projection lens 17. However, since the opening is arranged behind the screen 11, another worker in front of the screen 11 is needed for observing the image formed on the screen 11. Therefore, the cooperation of the two workers is inconvenient and cause more consumption of manpower.

### SUMMARY OF THE INVENTION

Accordingly, the present invention is directed to a rear projection display, wherein the height of the projection lens is reduced by arranging a lens adjusting space under the screen and protruding the projection lens into the lens adjusting space. Therefore, in front of the screen, the worker can adjust the focal length of the projection lens and observe the projection effect immediately.

The present invention provides a rear projection display, which comprises a base, a frame, a back housing, a partition, a system module, and a detachable panel. The base has a front opening. The frame is disposed on the base, and the frame has a displaying opening for exposing a screen. The back housing is disposed on the base and connecting to one side of the frame. The partition is disposed within the base for defining a system space and a lens adjusting space in the base, wherein the lens adjusting space is located between the system space and the frame, the system space and the lens adjusting space are exposed by the front opening, and the partition has at least one lens arranging opening. The system module is disposed in the system space of the base, wherein the system module comprises an optical engine having a projection lens, which is disposed at the lens arranging opening of the partition and protrudes into the lens adjusting space. The detachable panel is disposed at the front opening of the base for sealing the system space and the lens adjusting space.

According to an embodiment of the present invention, the system module may further comprise a circuit board and at least one picture tube electrically connected to the circuit board.

According to an embodiment of the present invention, the system module may further comprise a speaker, which is electrically connected to the circuit board.

According to an embodiment of the present invention, the detachable panel and the screen are arranged at the same side of the base.

According to an embodiment of the present invention, the rear projection display may further comprise an optical lens assembly, which is disposed in the back housing.

Since the lens adjusting space is provided in the rear projection display of the present invention, the worker can directly adjust the focal length of the projection lens through the lens adjusting space. Therefore, the consumption of manpower and the burdensome steps of disassembling, assembling, and testing can be avoided. In other words, the production efficiency is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a conventional rear projection display.

FIG. 2 schematically illustrates a front view of the rear projection display in FIG. 1.

FIGS. 3A and 3B are three-dimensional and front views schematically illustrate a rear projection display according to one embodiment of the present invention.

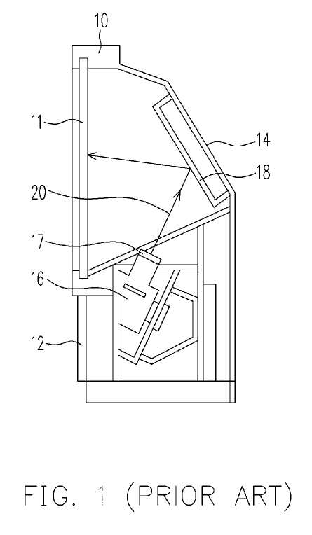

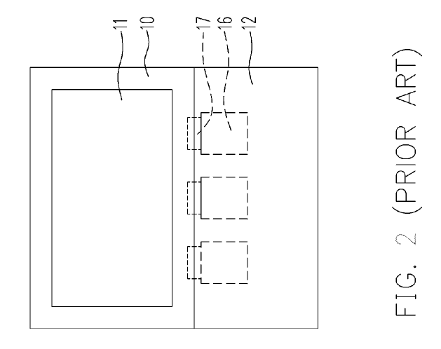

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

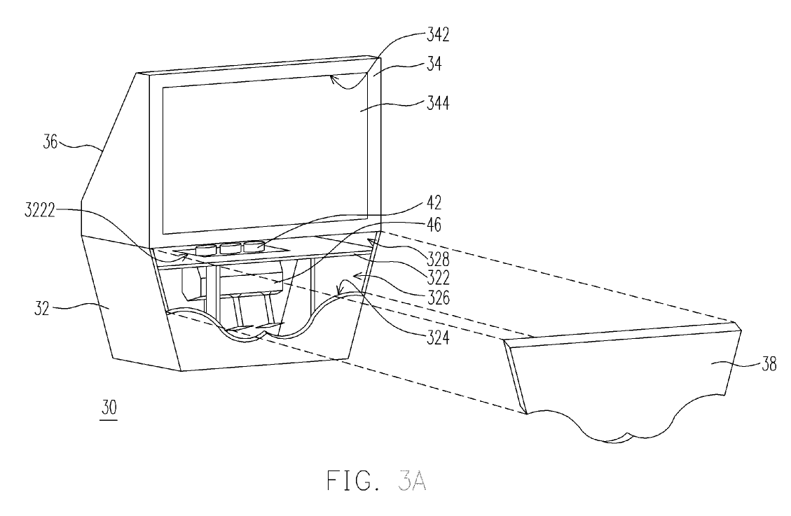

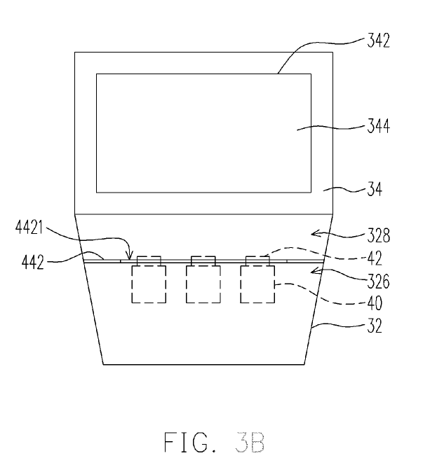

Referring to FIGS. 3A and 3B, which are three-dimensional and front views schematically illustrate a rear projection display according to one embodiment of the present invention. The rear projection display 30 mainly comprises a base 32, a frame 34, a back housing 36, a partition 322, an optical engine 40 having a set of projection lens 42, and a detachable panel 38. Wherein, the base 32 has a front opening 324, and the frame 34 is disposed on the base 32. For example, the front opening 324 and the frame 34 may be arranged at the same side of the base 32. The frame 34 has a displaying opening 342 for exposing a screen 344. In addition, the back housing 36 is disposed on the base 32 and behind the frame 34, wherein an optical lens assembly (not shown) is disposed in the back housing 36, and the optical lens assembly may comprises an optical lens, such as a reflector.

Referring to FIGS. 3A and 3B, the partition 322 is disposed within the base 32 for defining a system space 326 and a lens adjusting space 328 in the base. The system space 326 and the lens adjusting space 328 can be exposed by the front opening 324, and the lens adjusting space 328 is located between the system space 326 and the frame 34. In addition, the partition 322 has a lens arranging opening 3222, and the set of projection lens 42 are disposed at the lens arranging opening 3222 and protrude into the lens adjusting space 328.

A system module is disposed within the system space 326 of the base 32. The system module may comprise the optical engine 40 and other relative electronic devices, such as a circuit board, a picture tube electrically connected to the circuit board, a speaker, etc. The optical engine 40 is used for producing a light beam including image data. The light beam is focused by the set of projection lens 42 and transmitted to the optical lens assembly. Then, the optical lens assembly transmits the light beam to the screen 344 for displaying an image on the screen 344.

It should be noted that the amount of the projection lenses 42 is not limited. In the embodiment, the amount of the projection lenses 42 may be three for providing light beams in different color, such as red, blue, and green. As the focal length of the set of projection lens 42 is not correct, the light beam projected to the screen 344 can not be focused, and the image goes blurred. Therefore, the focal length of the set of projection lens 42 must be adjusted to focus the light beam to the screen 344 and improve the image displayed on the screen 344.

In the present invention, the set of projection lens 42 is arranged at the lens arranging opening 3222 of the partition 322 and protrudes into the lens adjusting space 328. The worker can directly adjust the focal length of the set of projection lens 42 in the lens adjusting space 328 through the front opening 324 of the base 32. At the same time, the image formed on the screen 344 can also be observed by the worker as the adjustment is performed.

In addition, the detachable panel 38 is disposed at the front opening 324 of the base 32. Ordinarily, the detachable panel 38 is used for sealing the system space 326 and the lens adjusting space 328 to protect the system module from dust or humidity. If it is necessary for adjusting the focal length of the projection lens 42 or repairing the system module, the detachable panel 38 can be detached from the base 32.

In summary, the present invention provides the lens adjusting space 328 by the partition 322 in the base 32, and the set of projection lens 42 protrudes into the lens adjusting space 328. Therefore, the worker can directly adjust the focal length of the set of projection lens 42 through the lens adjusting space 328 in front of the rear projection display and can observe the situation of projection simultaneously. The present invention can simplify the steps of assembling and testing, reduce the production time, and save the labor cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rear projection display, comprising:
a base, having a front opening;
a frame, disposed on the base, wherein the frame has a displaying opening for exposing a screen;
a back housing, disposed on the base, and connecting to one side of the frame;
a partition, disposed within the base for defining a system space and a lens adjusting space in the base, wherein the lens adjusting space is located between the system space and the frame, the system space and the lens adjusting space are exposed by the front opening, and the partition has at least one lens arranging opening;
a system module, disposed in the system space of the base, wherein the system module comprises an optical engine having a projection lens, which is disposed at the lens arranging opening of the partition and protrudes into the lens adjusting space; and
a detachable panel, disposed at the front opening of the base for sealing the system space and the lens adjusting space.

2. The rear projection display according to claim 1, wherein the system module further comprises:
a circuit board; and
at least one picture tube, electrically connected to the circuit board.

3. The rear projection display according to claim 1, wherein the system module further comprises a speaker, which is electrically connected to the circuit board.

4. The rear projection display according to claim 1, wherein the detachable panel and the screen are arranged at the same side of the base.

5. The rear projection display according to claim 1, further comprising an optical lens assembly, which is disposed in the back housing.
